(19) United States
(12) Patent Application Publication
(10) Pub. No.: US 2026/0077309 A1
(43) Pub. Date: Mar. 19, 2026

(54) METHOD AND SYSTEM FOR STORING CARBON DIOXIDE IN AN INDUSTRIAL WASTE SUSPENSION

(71) Applicant: Neustark AG, Bern (CH)

(72) Inventors: Johannes Tiefenthaler, Zürich (CH); Luca Tschurtschenthaler, Toffen (CH); Marcel Eckstein, Fribourg (CH)

(73) Assignee: Neustark AG, Bern (CH)

(21) Appl. No.: 19/138,440

(22) PCT Filed: Dec. 21, 2023
(86) PCT No.: PCT/EP2023/087399

§ 371 Date: Jun. 12, 2025

(30) Foreign Application Priority Data
Dec. 23, 2022 (CH) CH001582/2022

(51) Int. Cl. B01D 53/80; B01D 53/34; B01D 53/62

(52) U.S. Cl. CPC B01D 53/80; B01D 53/346; B01D 53/62; B01D 2251/404; B01D 2251/604; B01D 2257/504; B01D 2258/0233

(57) ABSTRACT

The disclosure relates to a method and a system for storing carbon dioxide in an industrial waste suspension. The method includes the following method steps: a. Providing a collection container containing the industrial waste suspension; b. Supplying of a volume flow of gas comprising carbon dioxide into the industrial waste suspension such that the industrial waste suspension is enriched with carbon dioxide, wherein at least part of the carbon dioxide is mineralized in the industrial waste suspension; c. Determining a loss of carbon dioxide from the carbon dioxide enriched industrial waste suspension; d. Determining an amount of mineralized carbon dioxide from the supplied carbon dioxide and the loss of carbon dioxide.

### CROSS-REFERENCE TO RELATED APPLICATIONS

This application is a U.S. National Stage Application that claims priority to and the benefit of the filing date of International PCT Application No. PCT/EP2023/087399, filed on Dec. 21, 2023, that claims priority to Swiss Application No. CH001582/2022, filed on Dec. 23, 2022, each of which are hereby incorporated by reference in their entirety.

### TECHNICAL FIELD

The disclosure relates to a method and a system for storing carbon dioxide in an industrial waste suspension.

### BACKGROUND

In the Paris Climate Agreement, the participating parties agreed that the increase in the global average temperature should be limited to below 2° C. and efforts should be made to stop it at 1.5° C. This means that greenhouse gas emissions should be reduced to net zero by 2050. To achieve this goal, storage solutions are needed for unavoidable carbon dioxide emissions from industrial processes. Storage options should thus be able to contain more than 10 Gt carbon dioxide annually and globally by 2050.

### SUMMARY

The disclosure is directed to the exploitation of industrial waste suspensions as a carbon dioxide storage medium. Typical industrial waste suspensions are water-based. Examples for industrial waste suspensions are sludges from the cleaning of concrete mixing plants or from washing of sand and/or gravel. Another example of an industrial waste suspension is a slag from the iron or steal production (such as e.g. blast furnace slag, electric arc furnace slag and/or basic oxygen furnace slag). Also possible are sludges, respectively slags comprising ashes (such as waste incineration ashes, sewage sludge ashes, wood ashes, paper incineration ashes and/or coal ashes). Furthermore, sludges, respectively slags comprising dust (such as cement bypass dust and/or cement kiln dust) can be used.

The invention relates to a method for storing carbon dioxide in an industrial waste suspension. The method comprises the following method steps: a) Providing a collection container containing the industrial waste suspension. b) Supplying of a volume flow of gas comprising carbon dioxide (also referred to in the following as “supplied gas”) into the industrial waste suspension such that the industrial waste suspension is enriched with carbon dioxide (respectively carbon dioxide enriched industrial waste suspension is formed). Thereby at least part of the carbon dioxide is mineralized in the industrial waste suspension (respectively industrial waste suspension with mineralized carbon dioxide is formed). c) Determining a loss of carbon dioxide from the carbon dioxide enriched industrial waste suspension. d) Determining an amount of mineralized carbon dioxide from the supplied carbon dioxide of the volume flow of gas (comprising carbon dioxide) and the loss of carbon dioxide. Hereby, the method steps b and c, in particular b-d can be performed continuously or in a repetitive manner. Advantageously, the method is performed in a continuously or in a repetitive manner until a termination criteria is reached.

The industrial waste suspension preferably has an initial pH-value such that the carbon dioxide can be mineralized. In some embodiments the initial pH-value can be larger than 6. However, preferably, the initial pH-value is larger than 9 and more preferably larger than 12. Depending on the application, the industrial waste suspension can e.g. be concrete wash water.

In some embodiments the industrial waste suspension comprises, or consists of, an aqueous solution and solids cement minerals. The water of the aqueous solution may thereby be in phase equilibrium with the solid cement minerals. In some embodiments, the industrial waste suspensions may comprise calcium ions, which are at least partially dissolved in the aqueous solution.

In context of this application, carbon dioxide mineralization is understood to mean that the carbon dioxide undergoes a chemical reaction, whereby carbon dioxide is mineralized. E.g. by reaction with the suspended cement minerals and/or hydroxyl ions of the industrial waste suspension. The mineralization of carbon dioxide results in the formation of carbonate and/or bicarbonate containing precipitate. The precipitate may preferably comprise calcium and particularly be at least partly calcium carbonate. Due to the precipitation of calcium carbonate, the aqueous solution of the industrial waste suspension becomes undersaturated resulting in turn in more calcium ions to be dissolved in the aqueous solution (until the saturation limit is reached again). The newly dissolved calcium ions in turn allow yet again for mineralizing additional carbon dioxide. Thus, in order to store as much carbon dioxide as possible into the industrial waste suspension, the mineralization would need to be performed in a continuous or repetitive manner, until no more calcium ions are dissolved.

Depending on the application, the determination of the loss of carbon dioxide may include monitoring an excessive gas discharged from the carbon dioxide enriched industrial waste suspension. It is understood that monitoring the excessive gas may also be understood as monitoring if excessive gas is discharged or not. If no excessive gas is discharged, the loss of carbon dioxide (at that time) is zero. The monitoring of the excessive gas can include measuring a carbon dioxide concentration in the excessive gas and/or by measuring a volume flow of excessive gas. From both measured values, the loss of carbon dioxide (respectively the amount of not mineralized carbon dioxide) can be determined. Both of the measured values may however be zero resulting in zero loss of carbon dioxide. If the supplied gas comprises 100% carbon dioxide, measuring a volume flow of the excessive gas may be sufficient. Depending on the application, the method may include that the discharged excessive gas is separated from the industrial waste suspension with the mineralized carbon dioxide and fed back into a storage tank providing the supplied gas.

As explained above, the loss of carbon dioxide may be zero at least for a certain duration of the method being performed. This is because only a limited amount of carbon dioxide can be mineralized by the industrial waste suspension and excessive gas discharged from the industrial waste suspension may occur if the limited amount is reached. Furthermore, the mineralization of carbon dioxide over time is not linear: the mineralization rate (mineralization of carbon dioxide per time step) decreases, the more carbon dioxide is mineralized. The mineralization rate further depends on the individual composition of the industrial waste suspension. Hence, if the mineralization rate of carbon dioxide (at any point in time) is surpassed, excessive gas may also be discharged from the industrial waste suspension. Since, the (total) amount of mineralizable carbon dioxide depends on the individual composition of the industrial waste suspension, the exact value of the maximal mineralization rate (at any point in time) as well as amount of mineralizable carbon dioxide are in generally not known before or while performing the method.

In order to provide an economically efficient process, the method can be controlled such that the industrial waste suspension is fed only as much carbon dioxide as can be mineralized. In order to not overfeed the industrial waste suspension and thus supply more carbon dioxide than can be mineralized, the method may include that the volume flow of gas comprising carbon dioxide (volume flow of supplied gas) and/or the volume flow of the industrial waste suspension is controlled by a control unit. Advantageously, the control unit may control the respective volume flows by active control as a function of the loss of carbon dioxide. E.g. if a loss of loss of carbon dioxide is detected, the volume flow of supplied gas can be reduced by the control unit until only as much supplied gas is fed into the volume flow of industrial waste suspension as can be mineralized.

In order to quantify the amount of mineralized carbon dioxide, the loss of carbon dioxide (respectively the amount of not mineralized carbon dioxide) can be subtracted from an amount of supplied carbon dioxide within the (supplied) volume flow of gas comprising carbon dioxide. To determine the amount of supplied carbon dioxide, the method may include measuring a carbon dioxide concentration of the supplied volume flow of gas comprising carbon dioxide by a concentration sensor and/or measuring the supplied volume flow of gas comprising carbon dioxide by a flow meter. If the concentration of carbon dioxide in the supplied gas is 100%, it is sufficient to measure only the supplied volume flow of gas to calculate the amount of supplied carbon dioxide.

However, the volume flow of gas comprising carbon dioxide can also include gaseous water and/or nitrogen and/or oxygen and/or methane in addition to carbon dioxide. The supplied gas may be stored as a liquid and/or as a gas in a storage tank before being supplied into the industrial waste suspension. Advantageously, the gas comprises 95% to 100% carbon dioxide. Depending on the application, the gas may comprise renewable carbon dioxide. Renewable carbon dioxide is understood to mean biogenic carbon dioxide or carbon dioxide extracted from the atmosphere. Biogenic carbon dioxide has the advantage that it can usually be obtained in pure form and does not need to be processed. Biogenic carbon dioxide can be obtained, for example, as a by-product of bio methane production or from the combustion of biomass (biological material comprising carbon, hydrogen and oxygen). Alternatively, the gas may also be an exhaust gas comprising 10-25% carbon dioxide. For example, an exhaust gas from a cement plant can be used.

For an easily controllable system, it is advantageous to perform the mineralization not within the voluminous collection container, but outside of the collection container in a (defined) volume flow of the industrial waste suspension. Therefore, a volume flow of the industrial waste suspension can be led through a bypass (leading in a circular manner from the collection container back in the collection container). Hence, the method may include the following method steps: Extracting of a volume flow of the industrial waste suspension from the collection container. Supplying the volume flow of gas comprising carbon dioxide into the volume flow of industrial waste suspension outside of the collection container (modified step b), wherein at least part of the carbon dioxide is mineralized in the industrial waste suspension. Returning the industrial waste suspension with the mineralized carbon dioxide into the collection container. These steps can be performed continuously or in a repetitive manner, in particular together with the aforementioned method step c) (or method step c) and d)). If the industrial waste suspension has been enriched once completely with the gas comprising carbon dioxide, the mineralization can be repeated (e.g. until no more calcium ions are dissolved or the termination criteria is reached).

Depending on the application, the control unit may control the volume flow of the industrial waste suspension, in particular by active control. Therefore, the control unit can be interconnected to a pump for pumping the industrial waste suspension through the bypass. Hence, in order to not overfeed the industrial waste suspension and thus supply more carbon dioxide than can be mineralized, the volume flow of gas comprising carbon dioxide and/or the volume flow of the industrial waste suspension can be reduced by the control unit if a loss of loss of carbon dioxide is detected.

Depending on the application, the method may comprise the method step of transferring the carbon dioxide enriched industrial waste suspension into an intermediate container, where discharged excessive gas is separated/is separable from the industrial waste suspension with the mineralized carbon dioxide and the industrial waste suspension with the mineralized carbon dioxide is returned into the collection container.

The intermediate container offers the advantage of an easy feedback signal for controlling the volume flow of gas comprising carbon dioxide and/or the volume flow of the industrial waste suspension as a function of the loss of carbon dioxide. The level of the industrial waste suspension in the intermediate container remains constant if no excessive gas is discharged. In context of this application constant is understood as within a range of +/−15 mm. If excessive gas is discharged, respectively separated from the industrial waste suspension with the mineralized carbon dioxide, the level of the industrial waste suspension in the intermediate container lowers. Thus, the level of the industrial waste suspension in the intermediate container is a measure of the loss of carbon dioxide. The same is true for the hydrostatic pressure in the industrial waste suspension in the intermediate container. Hence, the method may include that the volume flow of gas comprising carbon dioxide is controlled in such a way, that a level of the industrial waste suspension (with mineralized carbon dioxide) in the intermediate container is held constant. Therefore, the method may include that a level sensor determines the level of the industrial waste suspension in the intermediate container. The level sensor may e.g. be an optical sensor such as a laser or infrared sensor. Alternatively, a pressure sensor at a defined position within the intermediate container can be used, whereby the hydrostatic pressure is a measure of the loss of carbon dioxide. Hence, the amount of supplied gas comprising carbon dioxide (respectively a volume flow of gas comprising carbon dioxide) can be reduced by the control unit and/or the volume flow of the industrial waste suspension can be reduced by the control unit if the level and/or the hydrostatic pressure of the industrial waste suspension (with the mineralized carbon dioxide) lowers in the intermediate container. Depending on the application, the method may include that the carbon dioxide enriched industrial waste suspension is stirred to improve the mineralization of carbon dioxide. If an intermediate container is used, the stirring of the carbon dioxide enriched industrial waste suspension is advantageously performed upstream of the intermediate container. An appropriately shaped/coiled pipe segment (of the bypass) can archive the stirring and/or stirring elements located in the bypass. The stirring elements located in the bypass are preferably static (such as ribs or fins).

During the mineralization of the carbon dioxide in from the industrial waste suspension, the industrial waste suspension (with the mineralized carbon dioxide) becomes less alkaline, respectively the pH-value decreases. As the mineralization rate decreases over time it can be economically inefficient to perform the method until all supplied gas is discharged again as excessive gas and no more carbon dioxide can be mineralized. As the mineralization rate decreases also the pH-value decreases. Therefore, an easy to measure and detect termination criteria is the pH-value of the industrial waste suspension. Hence, the method may include terminating upon a predefined pH-value of the industrial waste suspension being reached. Thereby, the predefined pH-value should be smaller than the initial pH-value. In some embodiments, the method may be terminated, if a predefined pH-value between 7 and 10, in particular between 8.5 and 9.5, is reached. Depending on the application, the pH-value of the industrial waste suspension may be measured in the collection container. If a bypass is used, the pH-value may be measured in the bypass before the gas comprising carbon dioxide is fed into the industrial waste suspension. Alternatively or additionally, the method may include terminating upon a predefined value of the mineralized carbon dioxide per time or per cubic meter of the industrial waste suspension being reached. E.g. the method may be terminated, if mineralized carbon dioxide per cubic meter of 0.3-2 kg is reached. Alternatively the method may also be terminated if 2000-5000 ppm of carbon dioxide in the air above the collection container or the intermediate container is detected (this corresponds to 0.2%-0.5% of carbon dioxide in the air).

The invention further relates to a system (also referable to as plant) for storing carbon dioxide in an industrial waste suspension. The system is preferably capable to perform the above-described method for storing carbon dioxide in an industrial waste suspension.

The system thereby comprises a collection container for an industrial waste suspension with at least one opening for filling and/or extracting the industrial waste suspension and an inlet valve interconnected to a storage tank for gas comprising carbon dioxide. The inlet valve serves to supply a volume flow of the gas comprising carbon dioxide into the industrial waste suspension. Furthermore, the system comprises at least one sensor for determining a loss of carbon dioxide and a control unit interconnected to the at least one sensor for monitoring the loss of carbon dioxide and for determining an amount of mineralized carbon dioxide from the supplied carbon dioxide and the loss of carbon dioxide. Preferably the at least one sensor is a carbon dioxide concentration sensor. Furthermore at least one sensor may be present and interconnected to the control unit to monitor a termination criteria.

Depending on the application, the system may comprise a bypass for feeding a volume flow of the industrial waste suspension from an outlet out of the collection container in a circular manner to an inlet into the collection container. The bypass may thus comprise a pipe. Hereby the inlet valve (for the gas comprising carbon dioxide) is arranged such that the gas comprising carbon dioxide is fed (at a supply location) into the volume flow of the industrial waste suspension between the outlet and the inlet of the bypass. Advantageously, the bypass further comprises an intermediate container. Preferably the intermediate container is arranged downstream of the inlet valve. The intermediate container serves to separate discharged excessive carbon dioxide from the industrial waste suspension with the mineralized carbon dioxide. Preferably the intermediate container is a rise tube. From the intermediate container the industrial waste suspension with the mineralized carbon dioxide is led back into the collection container. A further feedback pipe can be arranged between the intermediate container and the storage tank for the separated excessive gas comprising carbon dioxide. For a good mineralization, stirring elements can be arranged between the supply location (where the gas comprising carbon dioxide is fed into the industrial waste suspension) and the intermediate container to stir the carbon dioxide enriched industrial waste suspension.

Depending on the application, the system can comprise a concentration sensor for measuring a carbon dioxide concentration of the supplied volume flow of gas comprising carbon dioxide and/or a flow meter for measuring the supplied volume flow of gas comprising carbon dioxide. The concentration sensor and/or the flow meter are thereby interconnected to the control unit, such that the control unit can determine the amount of mineralized carbon dioxide from the supplied carbon dioxide and the loss of carbon dioxide.

Depending on the application, at least one sensor for determining the loss of carbon dioxide is arranged in the intermediate container and/or the collection container. Furthermore, a level sensor for measuring a level of the industrial waste suspension in the intermediate container and/or a pressure sensor for measuring a hydrostatic pressure in the intermediate container can be arranged in the intermediate container in order to avoid overfeeding of carbon dioxide into the industrial waste suspension, as explained above.

It is to be understood that both the foregoing general description and the following detailed description present embodiments, and are intended to provide an overview or framework for understanding the nature and character of the disclosure. The previously described embodiments of the method disclose at the same time correspondingly designed embodiments of the system for carrying out the method and vice versa. The accompanying drawings are included to provide a further understanding, and are incorporated into and constitute a part of this specification. The drawings illustrate various embodiments, and together with the description serve to explain the principles and operation of the concepts disclosed.

### BRIEF DESCRIPTION OF THE DRAWINGS

The disclosure provided herein will be more fully understood from the detailed description given herein below and the accompanying drawings, which should not be considered limiting to the invention described in the appended claims. The drawings are showing:

FIG. 1 A flow diagram of a method for storing carbon dioxide in an industrial waste suspension;

FIG. 2 A flow diagram of the method according to FIG. 1 with further optional method steps;

FIG. 3 A schematic view of an example of a system for performing a method according to the invention.

### DETAILED DESCRIPTION

Reference will now be made in detail to certain embodiments, examples of which are illustrated in the accompanying drawings, in which some, but not all features are shown. Indeed, embodiments disclosed herein may be embodied in many different forms and should not be construed as limited to the embodiments set forth herein; rather, these embodiments are provided so that this disclosure will satisfy applicable legal requirements. Whenever possible, like reference numbers will be used to refer to like components or parts.

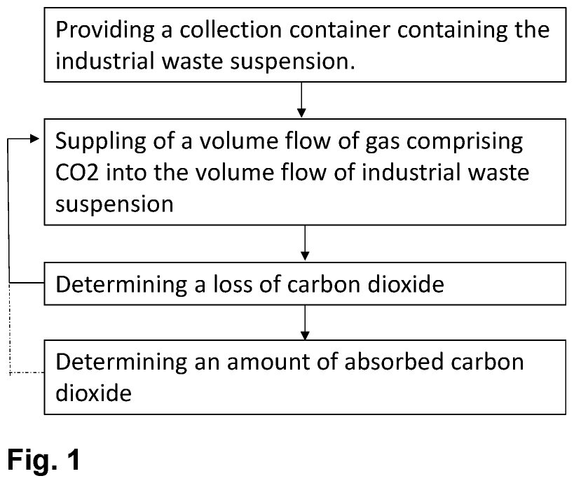

FIG. 1 shows a flow diagram of a method comprising the following method steps: a) Providing a collection container containing the industrial waste suspension. b) Supplying a volume flow of gas comprising carbon dioxide into the industrial waste suspension. This is done such that the industrial waste suspension is enriched with carbon dioxide, wherein at least part of the carbon dioxide is mineralized in the industrial waste suspension. c) Determining a loss of carbon dioxide from the carbon dioxide enriched industrial waste suspension and d) Determining an amount of mineralized carbon dioxide from the supplied carbon dioxide and the loss of carbon dioxide. Hereby, the method steps b) and c), in particular b)-d) are performed continuously or in a repetitive manner, as indicated in the arrow leading back to step b) on the left hand side of the flow diagram.

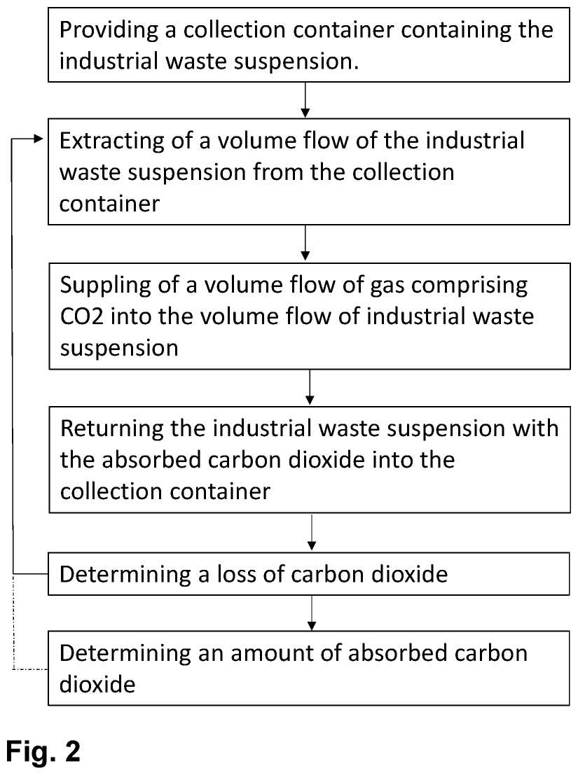

Even though the steps b) and/or c) can be done in the collection container, for a more efficient process it is advantageous to perform the/these step(s) outside of the collection container. Such a variation of the method according to the invention is shown in FIG. 2. Here, a volume flow of the industrial waste suspension is extracted from the collection container before the volume flow of gas comprising carbon dioxide is supplied into the volume flow of industrial waste suspension. After the volume flow of gas comprising carbon dioxide is supplied, the industrial waste suspension with the mineralized carbon dioxide can be returned into the collection container.

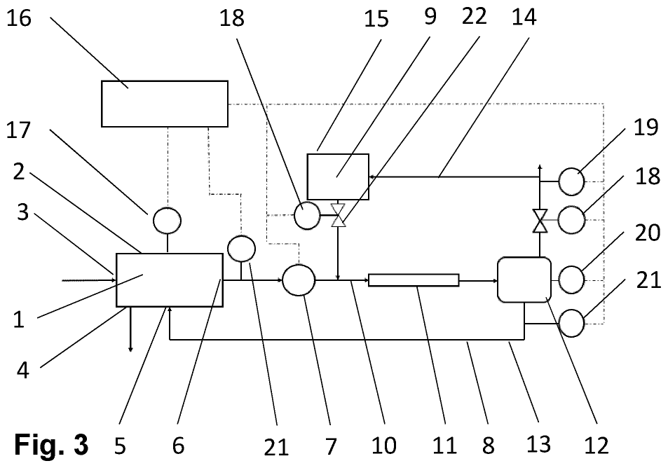

FIG. 3 shows a schematic view of a system /lant for storing carbon dioxide in an industrial waste suspension and in particular for performing a method according to the invention as described above. As can be seen, a collection container 2 containing the industrial waste suspension 1 is provided. The collection container 2 has an opening (entry) 3 for filling the industrial waste suspension 1 into the collection container. The entry 3 can e.g. be interconnected to a concrete mixing plant. The collection container 2 further has an opening (exit) 4 for extracting the industrial waste suspension 1 from the collection container 2, e.g. for further processing or for recycling of the industrial waste suspension 1 after the termination of the above-described method. In the shown system, a volume flow of the industrial waste suspension 1 is led in a circular manner through a bypass 8. The volume flow of the industrial waste suspension is transported through the bypass 8 by means of a pump 7. Thereby the industrial waste suspension 1 is led out of the collection container 2 through an outlet 6 into the bypass 8. Downstream of the outlet 8, an inlet valve 22 interconnected to a storage tank 15 for the gas comprising carbon dioxide 9 is arranged to supply the volume flow of gas comprising carbon dioxide 9 into the volume flow of industrial waste suspension 1 resulting in an industrial waste suspension enriched with carbon dioxide 10. In the bypass 8 downstream of the inlet valve 22 carbon dioxide is at least partly mineralized in the industrial waste suspension 1. To enhance the mineralization, stirring elements 11 such as vortex generators or other means can placed into the bypass 8. An intermediate container 12 can be arranged downstream of the inlet valve 22 (and downstream of the stirring elements 11, if present). In the intermediate container 12 excessive gas 14 comprising carbon dioxide can be separated from the industrial waste suspension with the mineralized carbon dioxide 13. From here, the industrial waste suspension with the mineralized carbon dioxide 13 is returned through an inlet 5 into the collection container 2. Excessive gas 14 can be fed back into the storage tank 15 providing the volume flow of gas comprising carbon dioxide 9.

To determine the amount of the loss of carbon dioxide, the excessive gas 14 may be monitored. Therefore, the system may include a concentration sensor 19 to measure a carbon dioxide concentration in the excessive gas 14. Alternatively or in addition, the system may comprise a flow meter 18 to measure a volume flow of the excessive gas 14. The measurement can be performed between the intermediate container 12 and the storage tank 15. Alternatively the measurements can be performed in the intermediate container 12. From both measured values, the amount of the not mineralized carbon dioxide, respectively the loss of carbon dioxide can be determined.

To determine the mineralized carbon dioxide per time step the loss of carbon dioxide per time step as well as the amount of supplied carbon dioxide per time step can be measured. Therefore, the system can comprise a further concentration sensor for measuring a carbon dioxide concentration of the supplied volume flow of gas comprising carbon dioxide 9 and/or a further flow meter 18 for measuring the supplied volume flow of gas comprising carbon dioxide 9. The measurements can be performed between the storage tank 15 and the inlet valve 22. In the shown system, the supplied gas 9 comprises 100% carbon dioxide. Hence, the flow meter 18 is sufficient to determine the supplied carbon dioxide per time step.

In order to provide an economically efficient process, the method can be controlled such that the industrial waste suspension 1 is fed only as much carbon dioxide as can be mineralized. In order to not overfeed the industrial waste suspension 1 and thus supply more carbon dioxide than can be mineralized, the method may include that the volume flow of the supplied gas 9 and/or the volume flow of the industrial waste suspension is controlled by a control unit 16. The control unit 16 may control the respective volume flows by active control as a function of the loss of carbon dioxide determined from a measured value of a level of the industrial waste suspension in the intermediate container 12. Hence, the method may include that the volume flow of gas comprising carbon dioxide is controlled in such a way, that a level of the carbon dioxide enriched industrial waste suspension in the intermediate container is held constant. Therefore, the system may comprise a level sensor 20 to determine a level of the industrial waste suspension in the intermediate container 12. Alternatively, a pressure sensor measuring a hydrostatic pressure can be used, such that the hydrostatic pressure is held constant by the control unit by active control.

For terminating the process, several options are available. The method may e.g. be terminated upon a predefined pH-value of the industrial waste suspension in the collection container 2 or in the bypass 8 being reached. Therefore, a pH-sensor 17 may be arranged in the collection container 1 or in the bypass 8. Additionally or alternatively, the method may include terminating upon a predefined value of the mineralization rate being reached. For monitoring, further sensors (such as pH-sensors or carbon dioxide concentration sensor) may be provided in the bypass, e.g. downstream of the outlet 6, in the intermediate container 12 and/or downstream of the intermediate container 12.

### LIST OF DESIGNATIONS

1 Industrial waste suspension
2 Collection container
3 Entry
4 Exit
5 Inlet
6 Outlet
7 Pump
8 Bypass
9 Supplied gas
10 Industrial waste suspension enriched with carbon dioxide
11 Stirring elements
12 Intermediate container
13 Industrial waste suspension with mineralized carbon dioxide
14 Excessive gas
15 Storage tank
16 Control unit
17 PH-sensor
18 Flow meter
19 Concentration sensor
20 Level sensor/pressure sensor
21 Additional sensor
22 Inlet valve

1. A method for storing carbon dioxide in an industrial waste suspension, said method comprising the following method steps:
a. Providing a collection container containing the industrial waste suspension;
b. Supplying of a volume flow of gas comprising carbon dioxide into the industrial waste suspension such that the industrial waste suspension is enriched with carbon dioxide, wherein at least part of the carbon dioxide is mineralized in the industrial waste suspension;
c. Determining a loss of carbon dioxide from the carbon dioxide enriched industrial waste suspension; and
d. Determining an amount of mineralized carbon dioxide from the supplied carbon dioxide and the loss of carbon dioxide.

2. The method of claim 1, wherein the method steps b and c, in particular b-d, are performed continuously or in a repetitive manner.

3. The method of claim 1, wherein the determination of the loss of carbon dioxide includes monitoring an excessive gas discharged from the carbon dioxide enriched industrial waste suspension.

4. The method of claim 3, wherein monitoring the excessive gas includes measuring a carbon dioxide concentration in the excessive gas and/or by measuring a volume flow of the excessive gas.

5. The method of claim 1, wherein the method includes
measuring a carbon dioxide concentration of the supplied volume flow of gas comprising carbon dioxide by a concentration sensor and/or
measuring the supplied volume flow of gas comprising carbon dioxide by a flow meter
to determine the supplied carbon dioxide.

6. The method of claim 1, wherein the method is terminated upon a predefined pH-value of the industrial waste suspension in the collection container being reached and/or upon a predefined value of the mineralized carbon dioxide per time being reached.

7. The method of claim 1, wherein the supply of the volume flow of gas comprising carbon dioxide into the industrial waste suspension comprises the following method steps:
Extracting of a volume flow of the industrial waste suspension from the collection container;
Supplying of the volume flow of gas comprising carbon dioxide into the volume flow of industrial waste suspension outside of the collection container, wherein carbon dioxide is at least partly mineralized in the industrial waste suspension; and
Returning the industrial waste suspension with the mineralized carbon dioxide into the collection container.

8. The method of claim 7, wherein the method comprises the method step of transferring the carbon dioxide enriched volume flow of industrial waste suspension into an intermediate container, where discharged excessive gas is separable from the industrial waste suspension with the mineralized carbon dioxide and the industrial waste suspension with the mineralized carbon dioxide is returned into the collection container.

9. The method of claim 8, wherein the volume flow of gas comprising carbon dioxide is controlled in such a way, that a level or a hydrostatic pressure of the industrial waste suspension with mineralized carbon dioxide in the intermediate container is held constant.

10. The method of claim 7, wherein the volume flow of gas comprising carbon dioxide and/or the volume flow of the industrial waste suspension is controlled by a control unit, in particular by active control as a function of the loss of carbon dioxide.

11. The method of claim 9, wherein the level of the industrial waste suspension in the intermediate container is determined by a level sensor and/or a pressure sensor measuring a hydrostatic pressure in the intermediate container.

12. The method of claim 8, wherein the carbon dioxide enriched industrial waste suspension stirred to facilitate the mineralization of carbon dioxide.

13. The method of claim 12, wherein the stirring of the carbon dioxide enriched industrial waste suspension is performed upstream of the intermediate container.

14. The method of claim 8, wherein the separated excessive is fed back into a storage tank providing the volume flow of gas comprising carbon dioxide.

15. A system for storing carbon dioxide in an industrial waste suspension, the system comprising
a. a collection container for an industrial waste suspension with at least one opening for filling and/or extracting the industrial waste suspension;
b. an inlet valve interconnected to a storage tank for gas comprising carbon dioxide for supplying a volume flow of the gas comprising carbon dioxide into the industrial waste suspension;
c. at least one sensor for determining a loss of carbon dioxide; and
d. a control unit interconnected to the at least one sensor for monitoring the loss of carbon dioxide and for determining an amount of mineralized carbon dioxide from the supplied carbon dioxide and the loss of carbon dioxide.

16. The system of claim 15, wherein the system comprises a bypass for feeding a volume flow of the industrial waste suspension from an outlet of the collection container in a circular manner to an inlet of the collection container, wherein the inlet valve is arranged such that the gas comprising carbon dioxide is fed into the volume flow of the industrial waste suspension in the bypass.

17. The system of claim 16, wherein the bypass comprises an intermediate container downstream of the inlet valve.

18. The system of claim 17, wherein stirring elements are arranged between intermediate container and of the inlet valve to mix the gas comprising carbon dioxide with the volume flow of carbon dioxide.

19. The system of claim 18, wherein at least one sensor for determining the loss of carbon dioxide is arranged in the intermediate container and/or the collection container.

20. The system of claim 19, wherein a level sensor for measuring a level of the industrial waste suspension in the intermediate container and/or a pressure sensor for measuring a hydrostatic pressure in the intermediate container is arranged in the intermediate container.

21. The system of claim 15, wherein the system comprises a concentration sensor for measuring a carbon dioxide concentration of the supplied volume flow of gas comprising carbon dioxide and/or a flow meter for measuring the supplied volume flow of gas comprising carbon dioxide.
